(19) United States
(12) Patent Application Publication
(10) Pub. No.: US 2022/0193714 A1
(43) Pub. Date: Jun. 23, 2022

(54) MULTI PART ASSEMBLY THAT SIMPLIFIES THE APPLICATION OF PRIMER SOLVENTS AND PLASTIC BONDING CEMENTS AND/OR AGENTS TO PLASTIC AND/OR PVC PIPING

(71) Applicant: MICHAEL DALE MCGEE, Lake Havasu City, AZ (US)

(72) Inventor: MICHAEL DALE MCGEE, Lake Havasu City, AZ (US)

(21) Appl. No.: 17/131,143

(22) Filed: Dec. 22, 2020

(51) Int. Cl. B05C 7/08; B05C 11/10; B05C 17/00; B05D 7/22; F16L 57/00

(52) U.S. Cl. CPC B05C 7/08; B05C 11/1002; F16L 57/00; B05D 7/225; B05C 17/002

(57) ABSTRACT

The present invention is a system and method facilitating the application of PVC primer or PVC cement to the inner surfaces of PVC unions, PVC sleeves, and the outer surfaces of PVC pipes. The invention consists of a PVC primer or PVC cement reservoir, a method of filing the PVC reservoir, and forcing the PVC primer or PVC cement through a series of tubes and holes in the apparatus and into a foam applicator which transfers the PVC primer or PVC cement onto the inner surface or onto the outer surface of a PVC union, PVC sleeve, or PVC pipe to a predetermined depth thus reducing waste of the PVC primer or PVC cement. The foam applicator housing contains a foam applicator specifically for applying PVC primer or PVC cement to either the inner surface of a PCV union, PVC sleeve, or to the outer surface of a PVC pipe giving a uniform application of PVC primer or PVC cement.

### FIELD OF INVENTION

The field of invention relates to devices that dispense primer solvent and plastic cement solutions onto the surfaces of plastic and/or PVC tubing in residential and commercial construction.

### BACKGROUND

New construction of residences and commercial structures more and more are using plastic and PVC piping for both interior and exterior applications. Typical application of both PVC primers and PVC cements onto the interior of PVC union connections and onto the exterior surface of PVC pipes generally results in either too little or too much PVC primer solvents and too little or too much PVC cement.

The result of over application of PVC primer solvents to the interior surfaces of PVC unions and PVC angled joints can cause roughening of the portion of the PVC union or PVC joint allowing particle matter traveling through the finished PVC piping surface to catch onto resulting in bacteria and algae growth. The under application of PVC primers to the interior surfaces of PVC unions and PVC angled joints can result in a weak bond when a PVC pipe coated on the exterior portion of the PVC pipe coated with PVC cement is inserted into the joint union. If the interior surface of the PVC union is not properly prepared with a PVC primer, the PVC cement on the surface of the inserted PVC pipe may not properly bond with the interior surface of the PVC union. This may result in a failed joint when the PVC pipe assembly is put under pressure.

The result of over application of the PVC cement results in PVC cement buildup inside the end of the PVC pipe where it is inserted into the PVC union. This buildup of plastic cement may result in microparticles of the PVC cement breaking off the buildup and flowing away in the liquid stream passing through the PVC pipe. If the liquid stream inside the pipe is water and is providing drinking water to people ingesting the water, the microparticles of the PVC pipe may be harmful to their health. Under application of PVC cement to the exterior of the PVC pipe the surface area of the bonding region between the PVC pipe and the PVC union is diminished. This may result in a failed joint when the PVC pipe assembly is put under pressure.

### Problem Statement:

What is needed is some device or system to guarantee the application of PVC primer and PVC cement to the exterior surface of the PVC pipe and the interior surface of the PVC union without over or under application of the PVC primer or the PVC cement thus facilitating a more perfect joining of the PVC pipe and PVC union.

### SUMMARY

The instant invention discloses a number of devices and systems to alleviate most or all of the problems if installing PVC thin and PVC heavy walled piping by simplifying the process of applying PVC priming solutions and PVC cements or other bonding solutions to making a joining of the PVC pipes permanent.

### Embodiments

Reference will now be made in detail to various embodiments, examples of which are illustrated in the accompanying drawings. Wherever possible, the same reference numbers will be used throughout the drawings to refer to the same or like parts.

A first exemplary embodiment is disclosed where a handheld applicator coats either the inside surface or outside surface of a large diameter PVC pipe with PVC primer or PVC cement. The maximum depth to which the applicator will apply the PVC primer or PVC cement to the inside surface or outside surface of the PVC pipe is set by the length of the throat that houses a foam applicator pad saturated with PVC primer or PVC cement. The reservoirs contained within the handheld applicator are communicatively coupled via a flexible tube to a can or other reservoir containing a pumping mechanism and PVC primer or PVC cement.

A related embodiment allows for removable plates where a first plate is a solid plate restricting the flow of PVC primer or PVC cement to the foam applicator pad and a second plate has a plurality of holes allowing the flow of PVC primer or PVC cement to the foam applicator pad secured to the plate. The plates snap into recesses between the foam applicator pads and the adjacent reservoirs. The top reservoir is used to coat the outer surface of large diameter pipes and as such when the hand applicator is used in this application, the plate residing between the cavity of the reservoir is the second plate and the plate residing between the cavity of the lower reservoir and the foam applicator pad is the first plate without flow holes.

A related embodiment is disclosed whereby each plate with or without a plurality of holes to allow PVC primer or PVC cement to flow through the plate and saturate the foam pad contains a physical stop fixture or tab that limits the distance to which the foam pad can extend from the end of the pipe to a predetermined distance to apply PVC primer or PVC cement (see FIGS. 9 and 10).

In a related embodiment the apparatus and system are alterable such that the application surface component of the invention may be changed such that the applicator (foam application pad) surface may apply PVC primer or PVC cement to the inner surface of a PCV pipe or joining sleeve or to the outer surface of a PVC pipe.

Another exemplary embodiment is disclosed whereby the pump mechanism is an electrical pump contained in the PCV primer or PCV cement reservoir and connected to a battery or power supply through a switch which can reverse the polarity of the conductors between the battery or power supply and the electrical pump. The switch allows the electrical pump to be operated such that PVC primer or PVC cement can be pumped from the PCV primer or PCV cement reservoir to the handheld applicator reservoir or to pump the PCV primer or PCV cement from the handheld applicator reservoir back to the PCV primer or PCV cement reservoir.

### Definitions

Flow Control Plate: The flow control plate is a rectangular plate located between the upper reservoir and the foam applicator pad. The upper or lower reservoir has an indent that receives the flow control plate. The flow control plate may have a plurality of flow control holes allowing PVC primer or PVC cement to flow through to the foam applicator pad and saturate the pad. The flow control plate may also be a solid plate that prevents any PVC primer or PVC cement from flowing to the foam applicator pad.

Flow control holes: The plurality of holes present on a flow control plate wherein the flow control holes allow PVC primer or PVC cement contained in one of the upper or lower reservoirs to flow through the flow control plate and saturate the foam applicator pad.

Foam Applicator Pad: a foam pad of various lengths fixed to either a sold flow control plate or a flow control plate with flow control holes.

PVC Primer: The purpose of PVC primer is to begin the chemical reaction that softens PVC materials and to provide an even prepped surface for the PVC solvent cement.

PVC Cement: PVC Cement is a PVC solvent for PVC pipe connected to PVC sleeves and PVC unions through PVC solvent welding.

### BRIEF DESCRIPTION OF THE DRAWINGS

FIG. 1 is a side view depiction of a PVC reservoir can and associated parts for manual pumping and connection part for a tube communicably coupling the PVC reservoir to the hand applicator.

FIG. 2 is a side view depiction of a liquid pump prior art.

FIG. 3 is a side view depiction of a liquid pump shown in dotted lines inside a PVC primer or PVC cement can or similar reservoir.

FIG. 4 is a side view of a PVC reservoir with a liquid pump (shown in dotted lines) extending through a spring mechanism and cap with a lift tube extending above the assembly for connection to a flexible tube.

FIG. 5 is a side view of the invention intended for applying PVC primer or PVC cement to the inside and outside of a large diameter PVC pipe (not shown) showing the applicator and PVC primer or PVC cement reservoir with a pump assembly.

FIG. 6 is a cut away side view of the invention intended for applying PVC primer or PVC cement to the inside and outside of a large diameter PVC pipe (not shown) showing the applicator with the PVC primer or PVC cement reservoirs 110, 102, and 108 with flow control holes 114 to allow the PVC primer or PVC cement to saturate foam pad applicators 104 and 106 to receive PVC primer or PVC cement from reservoirs 110, 102, and 108.

FIG. 7 is an end view of the invention intended for applying PVC primer or PVC cement to the inside and outside of a large diameter PVC pipe (not shown) showing the applicator reservoirs 102, 108, and 110, foam pad applicators 104 and 106 to receive PVC primer or PVC cement from reservoirs 110, 102, and 108, flow plates 116 and 118, and physical stops 158.

FIG. 8 is a depiction of flow control plate 116 with flow control holes 114 allowing the flow of PVC primer or PVC cement to various of foam pads (not shown) and flow plate 118 with an absence of holes. Flow plate 118 stops the flow of PVC primer or PVC cement to the foam applicator pad that is not intended to dispense PVC primer or PVC cement to the foam pad.

FIG. 9 is a depiction of various flow control plates 160, 168, 176 and 184 with various pluralities of flow holes 114 whose numbers vary by the depth of PVC primer or PVC cement on the PVC pipe surface (not shown) being coated. and also depicts foam pads with physical stops for pipe diameters ranging from four inches to ten inches (see table 1)

FIG. 10 is a depiction of various flow control plates 200, 210, 220, 230, 240, and 250 with various pluralities of flow holes 114 whose numbers vary by the depth of PVC primer or PVC cement on the PVC pipe surface (not shown) being coated. and also depicts foam pads with physical stops for pipe diameters ranging from ten inches to 24 inches (see table 1)

FIG. 11 is a depiction of the PCV primer or PCV cement reservoir with an electrical pump contained in the PCV primer or PCV cement reservoir, a battery or power supply that provides power to the electrical pump and a switch which controls the polarity of the conductors carrying direct current to the electrical pump allowing it to the user to pump PCV primer or PCV cement to or from the handheld applicator.

FIG. 12 is a depiction of the handheld applicator with a switch on the main reservoir of the handheld applicator and a set of conductors that carry electrical power to the switch on the handheld applicator allowing the user to turn on the electrical pump contained in the PCV primer or PCV cement reservoir pumping the PCV primer or PCV cement from the PCV primer or PCV cement reservoir to the handheld applicator or to pump the PCV primer or PCV cement from the handheld applicator to the PCV primer or PCV cement reservoir.

### DETAILED DESCRIPTION OF THE INVENTION

Objects and advantages of the present invention will become apparent to those skilled in the art upon reading this description in conjunction with the accompanying drawings, in which like reference numerals have been used to designate like or analogous elements.

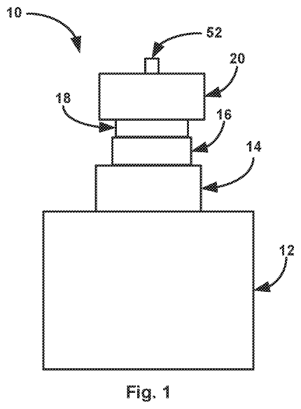

Now referencing FIG. 1 which is a side view depiction of the PVC reservoir 12, reservoir cap 14, upper and lower portion of spring mechanism 16 and 18, lift tube holder 20 and lift tube 52.

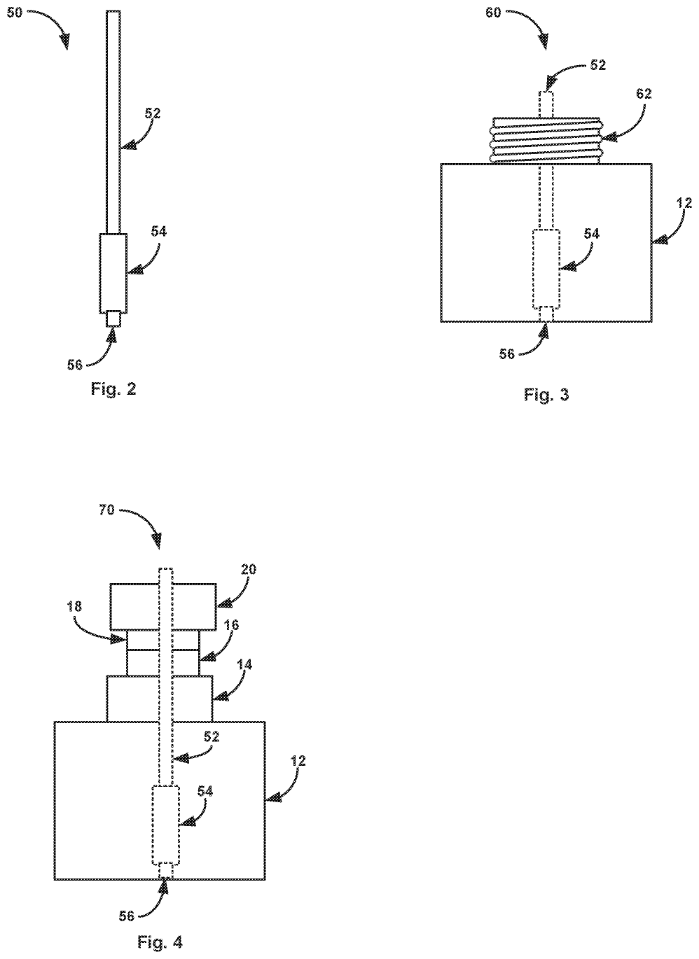

Now referencing FIG. 2 which is a side view depiction of a prior art liquid pump with pump mechanism 54, pump intake tube 56, and pump lift tube 52.

Now referencing FIG. 3 which is a side view depiction of a liquid pump shown in dotted lines inside a PVC primer or PVC cement reservoir can showing threaded opening 62 used to secure PVC reservoir cap 14 (not shown), and pump mechanism 52, 54, and 56.

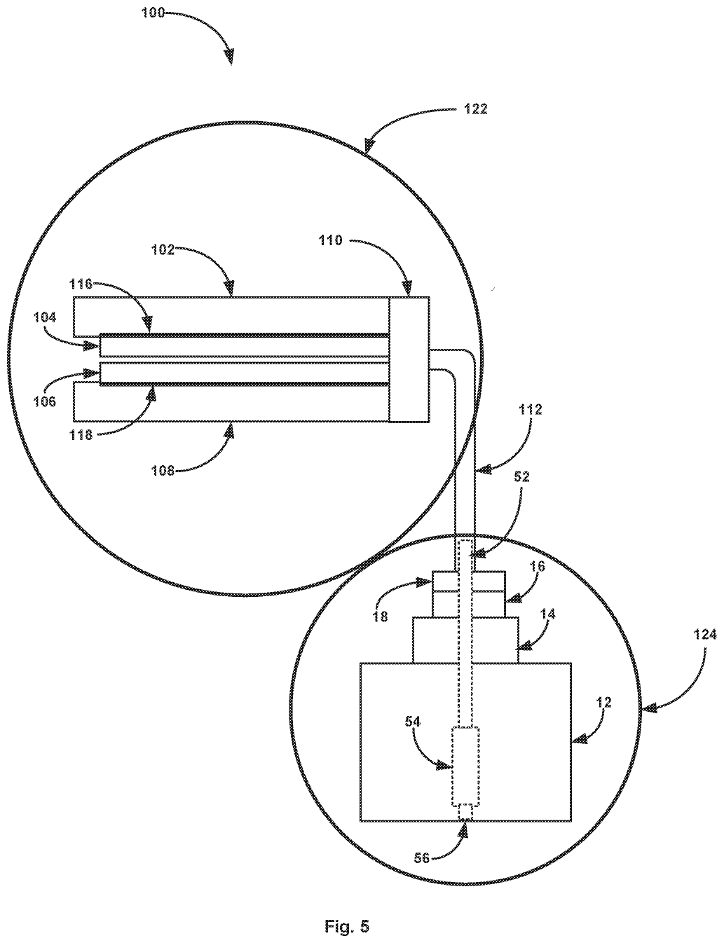

Now referencing FIG. 4 where 70 depicts the lift tube ,pump mechanism 52, 54, and 56 (shown in dotted lines), and intake tube assembly consisting of lift tube 52, pump mechanism 54, and pump intake tube 56. When lift tube 52 is pressed downward it moves into pump mechanism 54 (see FIGS. 4 and 5). A check value (not shown) in the body of pump mechanism 54 allows lift tube 52 to partly fill with PVC primer or PVC cement in its reservoir body. When lift tube 52 raises, pressure on lift tube pump mechanism 54 closes the check value (not shown) in the body of pump mechanism 54 allowing pump mechanism 54 to refill with PVC primer or PVC cement via pump mechanism intake tube 56. Repeated action of lift tube 52 fills with PVC primer or PVC cement results in flexible tube 112 and reservoirs 118, 102, and 108 (see FIG. 5) to be filled with PVC primer or PVC cement.

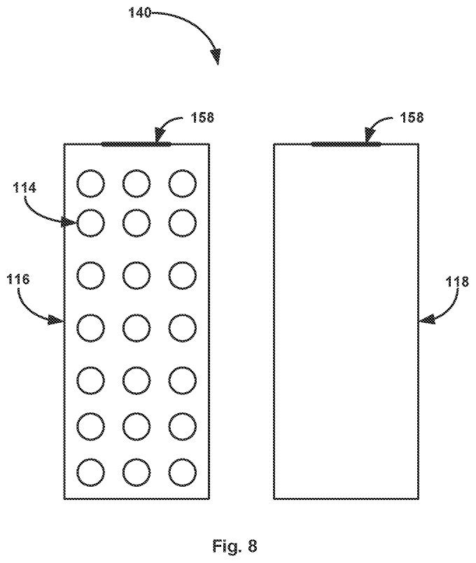

Now referencing FIG. 5 where 100 depicts a hand applicator 122 attached to PVC primer or PVC cement reservoir 12 assembly 124. Hand applicator 122 consists of flexible tube 112 communicable coupled to PVC primer or PVC cement reservoir 12 and to reservoir 110 of hand applicator 122. Hand applicator 122 consists of reservoir 110, upper reservoir 102 and lower reservoir 108. Upper reservoir 102 provides PVC primer or PVC cement to upper foam applicator pad 104 through upper flow control plate 116. Upper foam applicator pad 104 applies PVC primer or PVC cement to the outer surface of a large diameter PVC pipe (not shown). In practical use when PVC primer or PVC cement is applied to the outer surface of a large diameter PVC pipe (not shown), upper flow control plate 116 has a plurality of flow control holes 114 (FIGS. 8, 9, 10) allowing PVC primer or PCV cement to flow from upper reservoir 102 through a plurality of flow control holes 114 in upper flow control plate 116 and lower flow control plate 118 (FIG. 8) prevents PVC primer or PVC cement from flowing through lower flow control plate 118 (not shown) which has no flow control holes. Lower reservoir 108 provides PVC primer or PVC cement to lower foam applicator pad 106 through lower flow control plate 118. Lower foam applicator pad 106 applies PVC primer or PVC cement to the inner surface of a large diameter PVC pipe (not shown). In practical use when PVC primer or PVC cement is applied to the inner surface of a large diameter PVC pipe (not shown), lower flow control plate 118 has a plurality of flow control holes 114 (FIGS. 8, 9, 10) allowing PVC primer or PCV cement to flow from lower reservoir 108 through a plurality of flow control holes 114 in lower flow control plate 118 and upper flow control plate 116 (FIG. 8) prevents PVC primer or PVC cement from flowing through upper flow control plate 116 (not shown) which has no flow control holes.

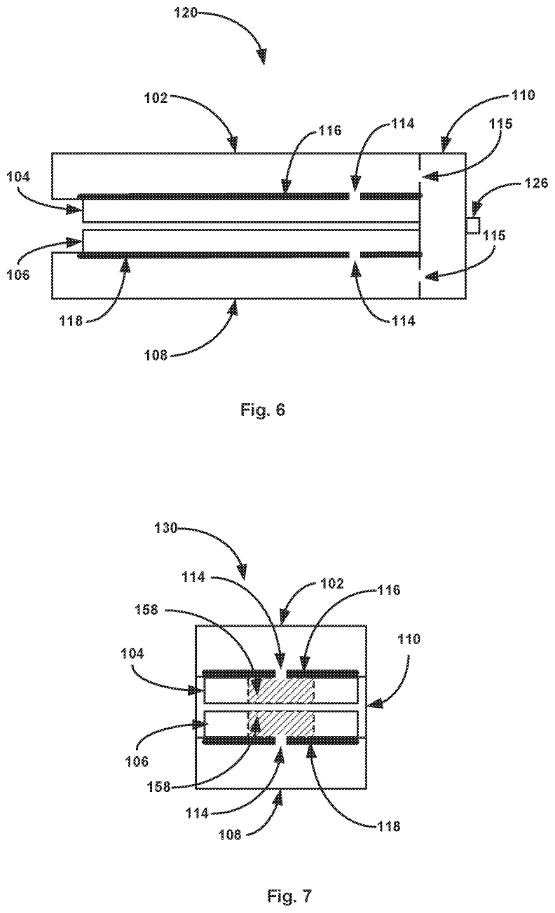

Now referencing FIG. 6 where applicator 120 is depicted showing all parts of the assembly. Applicator 120 consists of reservoir 110 with fill nipple 126. Fill nipple 126 receives flexible tube 112 (not shown) that carries PVC primer or PVC cement from reservoir assembly 124 (FIG. 5) to fill reservoir 110. Reservoir 110 is communicably coupled to upper reservoir 102 and lower reservoir 108. Reservoir 110 transfers PVC primer or PVC cement to upper reservoir 102 and lower reservoir 108 via flow control holes 114. Upper flow control plate 116 allows or blocks the flow of PVC primer or PVC cement from upper reservoir 102. If upper foam applicator pad 104 is to apply PVC primer or PVC cement to the outer surface of a large diameter PVC pipe (not shown), upper flow control plate 116 will have a plurality of flow control holes 114 and if foam applicator pad 104 is not to apply PVC primer or PVC cement to the outer surface of a large diameter PVC pipe (not shown), upper flow control plate 116 will not have a plurality of flow control holes 114 but will block any PVC primer or PVC cement from saturating foam applicator pad 104. Lower flow control plate 118 allows or blocks the flow of PVC primer or PVC cement from lower reservoir 108. If foam applicator pad 106 is to apply PVC primer or PVC cement to the inner surface of a large diameter PVC pipe (not shown), lower flow control plate 118 will have a plurality of flow control holes 114 and if foam applicator pad 106 is not to apply PVC primer or PVC cement to the inner surface of a large diameter PVC pipe (not shown), lower flow control plate 118 will not have a plurality of flow control holes 114 but will block any PVC primer or PVC cement from saturating foam applicator pad 106. If the user decides to apply PVC primer or PVC cement to both the inner and outer surfaces of a large diameter PVC pipe (not shown), both upper flow control plate 116 and lower flow control plate 118 will have a plurality of flow control holes 114 to allow PVC primer or PVC cement to flow into foam applicator pads 104 and 106.

Now referencing FIG. 7 where 130 depicts an end view of applicator 122 (FIG. 5). Reservoir 110 is shown not in its entirety but only that portion of reservoir 110 not obscured by upper reservoir 102 and lower reservoir 108. In the current depiction, upper reservoir 102 is shown with upper flow control plate 116 with flow control hole 114 that allows PVC primer or PVC cement to flow from upper reservoir 102 through flow control plate 116 to saturate upper foam applicator pad 104. Lower reservoir 108 is shown with lower flow control plate 118 with flow control hole 114 that allows PVC primer or PVC cement to flow from lower reservoir 108 through flow control plate 118 to saturate lower foam applicator pad 106. Also shown are physical stops 158 that limit the depth of PVC solvent or PVC cement onto the outside or inside of a large PVC pipe (not shown).

Now referencing FIG. 8 where 140 depicts an upper flow control plate 116 and lower flow control plate 118. In this depiction, upper flow control plate 116 has a plurality of flow control holes 114 allowing PVC primer or PVC cement to flow from upper reservoir 102 through upper flow control plate 116 (FIG. 6, 7) to upper foam applicator pad 104 (FIG. 6, 7). In this depiction, lower flow control plate 118 is intended to block any PVC primer or PVC cement from lower reservoir to lower foam applicator pad 106 (FIG. 6, 7). If the inside surface of a large diameter PVC pipe is to be coated with PVC primer or PVC cement, then upper flow control plate will lack any flow control holes 114 and will block any PVC primer or PVC cement from upper reservoir 102 to upper foam applicator pad 104, and lower flow control plate 118 will have a plurality of flow control holes 114 allowing PVC primer or PVC cement to flow from lower reservoir 108 through flow control plate 118 to saturate lower foam applicator pad 106. Note that in FIG. 8, physical stops 158 are depicted on both flow control plates 116 and 118. These physical stops 158 can be positioned and distanced from the opposite end of flow control plates 116 and 118. These physical stops 158 are intended to limit the distance from the open end of a large diameter PVC pipe (not sown) to the recommended length of the inner or outer surface of said pipe as recommended by the PVC primer or PVC cement manufacturer.

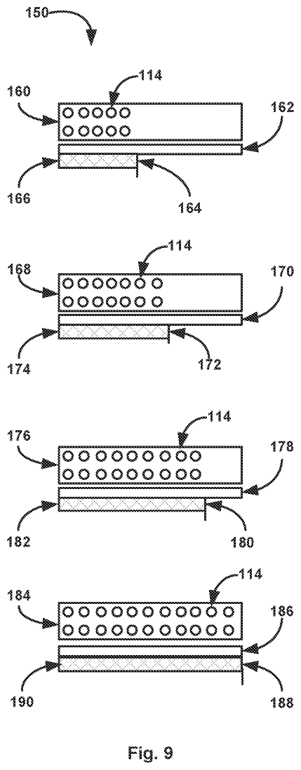

Now referencing FIG. 9 where 150 depicts flow control plates (either upper or lower flow control plates 116 or 118) where a plurality of flow control holes 114 are present to allow PVC primer or PVC cement to flow through to one of a plurality of foam applicator pads (104 or 106 not shown). In this depiction the depth of the PVC primer or PVC cement coating that will coat either the outer surface or inner surface of a large diameter PVC pipe (not shown) is limited by physical stops 158. For PVC pipe (not shown) in either schedule 40 or schedule 80 for diameters from 4-inches to 10-inches the depth of PVC primer or PVC cement application are shown in Table 1. Flow control plates and foam applicator pads with physical stops 158 are depicted with a top view with various pluralities of flow control holes 114. Top views of flow control plates are 160, 168, 176, and 184. The edge views of flow control plates are 162, 170, 178, and 186. Edge views of foam applicator pads are 166, 174, 182, and 190. The physical stops 158 attached to foam applicator pads are 164, 172 180, and 188. The distance from the opening end of the large diameter PVC pipe (not shown) is as the entry in Table 1 for diameters 4-inch through 10-inch.

TABLE 1

| Nominal | Primer or Cement | |
|---|---|---|
| Pipe | Application Depth | |
| Size | Sched 40 | Sched 80 |
| 4″ | 1.875″ | 1.875″ |
| 6″ | 3.000″ | 3.000″ |
| 8″ | 4.000″ | 4.000″ |
| 10″ | 5.000″ | 5.000″ |
| 12″ | 6.000″ | 6.000″ |
| 14″ | 7.000″ | 7.000″ |
| 16″ | 8.000″ | 8.000″ |
| 18″ | 9.000″ | 9.000″ |
| 20″ | 10.000″ | 10.000″ |
| 24″ | 12.000″ | 12.000″ |

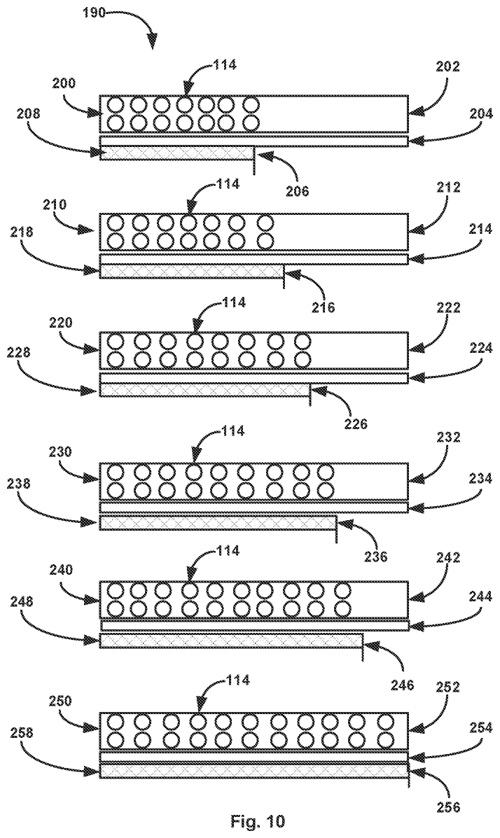

Now referencing FIG. 10 where 190 depicts flow control plates (either upper or lower flow control plates where a plurality of flow control holes 114 are present to allow PVC primer or PVC cement to flow through to one of a plurality of foam applicator pads). In this depiction the depth of the PVC primer or PVC cement coating that will coat either the outer surface or inner surface of a large diameter PVC pipe (not shown). For PVC pipe (not shown) in either schedule 40 or schedule 80 for diameters from 12-inches to 24-inches the depth of PVC primer or PVC cement application are shown in Table 1. Flow control plates and foam applicator pads with physical stops 158 are depicted with a top view with various pluralities of flow control holes 114. Top views of flow control plates are 200, 210, 220, 230, 240, and 250. The edge views of flow control plates are 204, 214, 224, 234. 244, and 254. Edge views of foam applicator pads are 208, 218, 228, 238, 248, and 258. The depth physical stops 158 attached to foam applicator pads are 206, 216, 226, 236, 246, and 256. The distance from the opening end of the large diameter PVC pipe (not shown) is as the entry in Table 1 for diameters 12-inches through 24-inches.

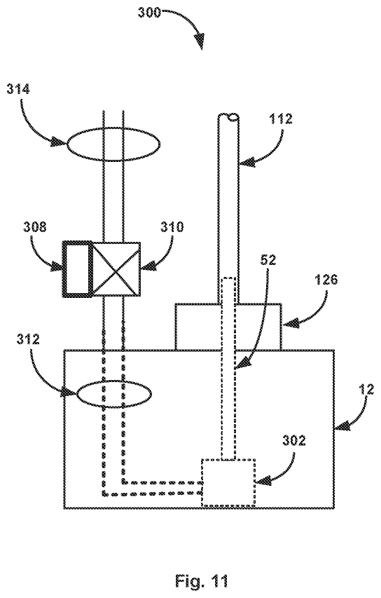

Now referencing FIG. 11 where 300 depicts reservoir 12 with an electrical pump 302 (shown in dotted lines) used to pump PVC primer or PVC cement from reservoir 12 to handheld applicator 350 (not shown) through flexible tube 112. In this depiction, electrical pump 302 derives its power to operate from battery or power supply 308. Battery or power supply 308 is communicable coupled to polarity switch 310. Polarity switch 310 sends electrical power to electrical pump 302 (shown in dotted lines) through conductor bundle 312. Polarity switch 310 is operated by the user. By manipulating polarity switch 310, the electrical polarity delivered to electrical pump 302 (shown in dotted lines) can be manipulated causing electrical pump 302 (shown in dotted lines) to pump PVC primer or PVC cement from reservoir 12 to handheld applicator 350 (not shown) or to pump PVC primer or PVC cement from handheld applicator 350 (not shown) to reservoir 12. Polarity switch 310 sends electrical power through control conductor bundle 314 to handheld applicator 350 (not shown). Control conductor bundle 314 comprises two conductors connected by pump control button 352 (not shown). When the user presses pump control button 352 (not shown) the electrical circuit composed of polarity switch 310, battery or power supply 308, and conductor bundle 312 is closed by pump control button 352 (not shown) and electrical current whose polarity is determined by polarity switch 310 is sent to electrical pump 302 (shown in dotted lines). Electrical pump 302 (shown in dotted lines) then pumps PVC primer or PVC cement from reservoir 12 to handheld applicator 350 (not shown) or to pump PVC primer or PVC cement from handheld applicator 350 (not shown) to reservoir 12. The pumping action of electrical pump 302 continues until the user ceases pressing of pump control button 352 (not shown).

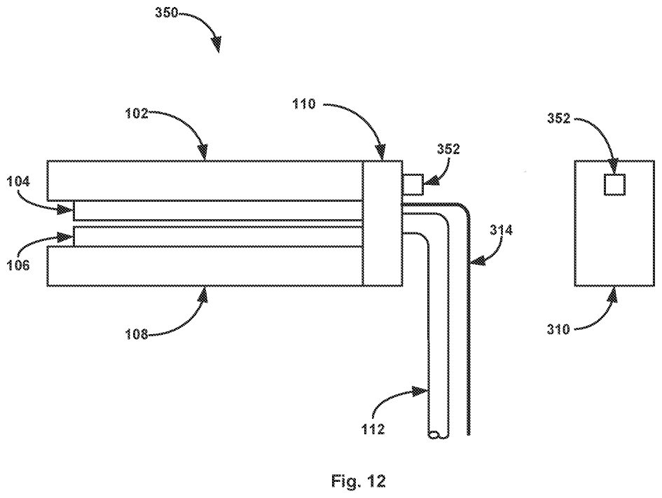

Now referencing FIG. 12 where 350 depicts handheld applicator with control conductor bundle 314, pump control button 352. In this depiction electrical current is sent from polarity switch 310 via control conductor bundle 314 to pump control button 352. The conductors contained in control conductor bundle 314 are connected through pump control button 352. Pump control button 352 connects the ends of the conductors contained in control conductor bundle 314 when pump control button 352 is pressed by the user. Electrical current flows through control conductor bundle 314, pump control button 352 to polarity switch 310 while the user presses pump control button 314 and ceases current flow when the user stops pressing pump control button 352.

The inventor intends that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A system for applying PVC primer or PVC cement to the joining surfaces of PVC pipes such that the amount of PVC primer or PVC cement applied to the outside or inside joining surfaces of said PVC pipe is of a uniform layer for the surface area to be covered by said PVC primer or PVC cement, said system comprising: a PVC primer or PVC cement reservoir container with an integral manually operated pump, a flexible tube transporting said PVC primer or PVC cement from said PVC primer or PVC cement reservoir container to a handheld PVC primer or PVC cement applicator, said handheld PVC primer or PVC cement applicator comprising, a main reservoir communicable coupled to two additional reservoirs, each providing PVC primer or PVC cement to a foam applicator pad, one said foam applicator pad applies PVC primer or PVC cement to the inner surface of a PVC pipe and one said foam applicator pad applies PVC primer or PVC cement to the outer surface of a PVC pipe, and a flow control plate positioned between each said foam applicator pad and a reservoir of PVC primer or PVC cement, said flow control plate contains a plurality of holes through which PVC primer or PVC cement flows to each said foam applicator pad, said system comprising the system elements of:
a. said integral manually operated pump and said pump tube residing in said PVC primer or PVC cement reservoir container holding said PVC primer or PVC cement communicably couples said PVC primer or. PVC cement reservoir container to said handheld PVC primer or PVC cement applicator applier and pumps said. PVC primer or PVC cement from said PVC primer or PVC cement reservoir container when said pump tube is manually depressed in a pumping action, and
b. said PVC primer or PVC cement flows from said PVC primer or PVC cement container through said pump tube into said handheld PVC primer or PVC cement applicator's main reservoir communicable coupled to two additional reservoirs each providing PVC primer or PVC cement through said flow control plates to said foam applicator pads, and
c. If said flow control plate contains a plurality of flow control holes said foam applicator pad will be saturated by said PVC primer or PVC cement and will apply said PVC primer or PVC cement to the inner or outer surface against said foam applicator pad is in contact with, and
d. If said flow control plate does not contain a plurality of flow control holes said foam applicator pad will not be saturated by said PVC primer or PVC cement and will not apply said PVC primer or PVC cement to the inner or outer surface against said foam applicator pad is in contact with.

2. The system of claim 1 where the length of either of said foam applicators contained in said handheld PVC primer or PVC cement applicator is the same as the depth recommended by the manufacturer of said PVC pipe thus limiting the PVC primer or PVC cement depth of the outer or inner surface area of said PVC pipe receiving said PVC primer or PVC cement.

3. The system of claim 1 where said foam applicator pad contains a physical stop tab at the end of said foam applicator pad. and whose height is the thickness of said foam applicator pad plus the thickness of the wall of said PVC pipe and said physical stop tab comes into contact with the open end of said PVC pipe preventing said handheld PVC primer or PVC cement applicator from entering into said PVC pipe or over the outer surface of the open end of said PVC pipe to a distance or depth greater than that distance recommended by the manufacturer of said PVC pipe for applying PVC primer or PVC cement to the joining surface of said PVC pipe.

4. The system of claim 1 where an electrically powered pump replaces said manually operated pump in said PVC primer or PVC cement reservoir container, and
said electrically powered pump is communicably coupled to a manually operated polarity switch operated by a user which determines the pumping direction of said electrically powered pump, and
a battery or power supply provides electrical current to said polarity switch, and said polarity switch is communicable coupled via a conductor bundle to an on/off switch on said handheld applicator, and
said on/off switch closes when pressed by said user, and
once said on/off switch is closed, said current flows from said battery or said power supply to said polarity switch to said electrical pump, and
said electrical pump, pumps PVC primer or PVC solvent from said reservoir to said handheld applicator and when said polarity switch is manipulated by said. user, said current flow from said polarity switch is reversed and said electrical pump reverses the pumping direction and pumps PVC primer or PVC solvent from said handheld applicator to said reservoir.

5. (canceled)

6. (canceled)

7. (canceled)

8. (canceled)
